(19) United States
(12) Patent Application Publication
(10) Pub. No.: US 2008/0049670 A1
(43) Pub. Date: Feb. 28, 2008

(54) METHOD AND APPARATUS FOR TRANSMITTING/RECEIVING DATA IN A WIRELESS ACCESS COMMUNICATION SYSTEM

(75) Inventors: Min-Hee Cho, Suwon-si (KR); Jae-Hee Cho, Seoul (KR); Jung-Je Son, Seongnam-si (KR); Nam-Gi Kim, Suwon-si (KR); Jae-Hyuk Jang, Buk-gu (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/844,207

(22) Filed: Aug. 23, 2007

(30) Foreign Application Priority Data
Aug. 24, 2006 (KR) 80734-2006

(51) Int. Cl. H04Q 7/00

(52) U.S. Cl. 370/329

(57) ABSTRACT

An apparatus for transmitting data in a wireless access communication system includes a rate request code selector for selecting a corresponding rate request code from among rate request codes predefined according to a traffic rate, and a transmitter for transmitting the selected rate request code to a Base Station (BS). The apparatus receives an uplink Media Access Protocol (MAP) from the BS, acquires uplink resource allocation amount information from the uplink MAP, selects a corresponding rate request code from among rate request codes predefined according to a traffic rate considering the uplink resource allocation amount information and a size of transmission data, and transmits uplink data including the selected rate request code to the BS.

### PRIORITY

This application claims priority under 35 U.S.C. §119(a) to a Korean Patent Application filed in the Korean Intellectual Property Office on Aug. 24, 2006 and assigned Serial No. 2006-80734, the contents of which are incorporated herein by reference.

### BACKGROUND OF THE INVENTION

1. Field of the Invention

The present invention relates generally to a communication system, and in particular, to a method and apparatus for transmitting/receiving data in a communication system supporting a Voice over Internet Protocol (VoIP) service.

2. Description of the Related Art

Intensive research on the next generation communication system is being conducted to provide high-speed services having various Quality of Service (QoS) classes to users. Particularly, active research on the next generation communication system is being performed to support high-speed services in the way of guaranteeing mobility and QoS for a Broadband Wireless Access (BWA) communication system such as a wireless Local Area Network (LAN) system and a wireless Metropolitan Area Network (MAN) system.

Meanwhile, VoIP, a technology for transmitting voice and data over the Internet, is a core technology for enabling Internet telephony. Unlike the prior art technology in which a network for data transmission/reception and a network for voice transmission/reception are separately managed, the VoIP technology integrates the voice network and the data network into one network, thereby providing noticeable advantages of simplifying the network configuration and reducing the cost of the added network infrastructure. Furthermore, the VoIP technology is a powerful tool of Internet telephony capable of reducing the high communication costs required for the long-distance call, such as toll call and international call, to the price level of the local call or to free charge anywhere all over the world. In the VoIP technology, when silence occurs between words spoken by a caller, a silence suppression technology detects it through voice activity detection, and avoids transmission of VoIP data. That is, the silence suppression technology determines whether an amplitude value of the voice reaches a limit to transmit no VoIP data in a silence interval corresponding to 50% of the total conversation time.

FIG. 1 illustrates a schematic configuration of a conventional communication system.

Referring to FIG. 1, a Base Station (BS) 100 communicates with a first Mobile Station or subscriber station (MS#1) 110, an MS#2 120 and an MS#3 130 over a wireless shared channel.

When the MS#1 110 to MS#3 130 receive the VoIP service over a wireless shared channel, they are allocated uplink resources from the BS 100, and transmit generated VoIP data to the BS 100 over the allocated uplink resources.

In the conventional communication system, a service class called ‘extended real-time Polling Service (ertPS)’ is defined to provide the silence suppression technology of the VoIP service. The ertPS can be used not only in the silence suppression technology but also in variable rate real-time application. When an uplink transport connection having the ertPS service class is generated, QoS parameters such as ‘Maximum Sustained Traffic Rate’ and ‘Unsolicited Grant Interval’ are exchanged between a BS and an MS. The Maximum Sustained Traffic Rate is set for every connection on a one-to-one basis, and for a voice service connection, the Maximum Sustained Traffic Rate indicates a traffic rate maximally allocable for the voice, and the Unsolicited Grant Interval indicates a resource allocation interval. It is assumed herein that an ertPS connection between the BS 100 and the MS#1 110 among the MSs 110 to 130 is connected. When the ertPS connection is generated between the MS#1 110 and the BS 100, the BS 100 starts allocating as many uplink wireless resources as Maximum Sustained Traffic Rate at intervals of Unsolicited Grant Interval.

The MS#1 110 can send a request for rate change to the BS 100 using ‘Bandwidth Request and Tx Power Report Header)’ or ‘Grant Management Sub header’. In addition, the MS#1 110 can make a request for rate change to Maximum Sustained Traffic Rate by transmitting a particular codeword, for example, ‘0b111011’, over a Channel Quality Information (CQI) channel.

FIG. 2 illustrates a conventional VoIP data transport frame.

Referring to FIG. 2, when a VoIP service using the silence suppression technology is provided through the ertPS service, if VoIP data is generated from a voice codec of an MS (see 200), the MS sends a request for rate change to a BS considering a size of a voice data queue for the generated VoIP data (see 210). A unit of the frame herein is based on 5 ms. When the MS sends a request for rate change to the BS, it sends the rate change request over a Medium Access Control (MAC) message.

Therefore, a time delay may occur due to a time for which the MS generates a MAC message, and a time for which the BS receives the MAC message from the MS and performs demodulation/decoding thereon and its MAC layer processes the message.

If an unsolicited grant interval of the BS is, for example, 20 ms depending on the rate change request message 210 transmitted from the MS to the BS, uplink resources are allocated to the MS every 20 ms. Therefore, the BS sends uplink resource allocation messages (UL-MAPs) 220 and 240, messages for allocating uplink resources, to the MS, for example, every 20 ms in response to the rate change request from the MS. However, after receiving the rate change request message 210, the BS cannot apply the rate requested by the MS to the UL-MAP 220 due to a delay in processing the rate change request message. As a result, the BS later applies the rate change to the UL-MAP 240 in response to the rate change request 210 from the MS, and allocates uplink resources (see 240). The MS transmits the VoIP data to the BS using the changed rate (see 250).

In conclusion, the total transmission delay time 260 of about 50 ms occurs from the generation time 200 of the VoIP data until upon receipt of the rate change request from the MS, the BS performs a change procedure to the rate requested by the MS and a data transmission procedure between the MS and the BS is performed at the changed rate.

In the foregoing conventional operation, the delay in rate change between the MS and the BS may cause a transmission delay time, thereby increasing mouth-to-ear latency for the VoIP data. This leads to call quality degradation that the user can experience, thus necessitating a minimization of the time required for rate change between the MS to the BS.

### SUMMARY OF THE INVENTION

An aspect of the present invention is to address at least the problems and/or disadvantages and to provide at least the advantages described below. Accordingly, an aspect of the present invention is to provide a method and apparatus for efficiently transmitting data in a communication system supporting a VoIP service.

An aspect of the present invention is to provide a method and apparatus for transmitting voice activity information of an MS using a code.

An aspect of the present invention is to provide a method and apparatus for receiving a code and allocating uplink resources corresponding thereto.

According to the present invention, there is provided an apparatus for transmitting data in a wireless access communication system, including a rate request code selector for selecting a corresponding rate request code from among rate request codes predefined according to a traffic rate, and a transmitter for transmitting the selected rate request code to a BS.

According to the present invention, there is provided an apparatus for receiving data in a wireless access communication system, including a receiver for receiving data including a rate request code predefined according to a traffic rate individually for each MS, a demodulator for extracting the rate request code from the received data, a rate request code processor for selecting a traffic rate corresponding to the extracted rate request code and allocating uplink wireless resources at the selected traffic rate, and a transmitter for transmitting the allocated uplink wireless resources to a corresponding MS.

According to the present invention, there is provided a method for transmitting data in a wireless access communication system, including receiving an uplink MAP from a BS, and acquiring uplink resource allocation amount information from the uplink MAP, selecting a corresponding rate request code from among rate request codes predefined according to a traffic rate considering the uplink resource allocation amount information and a size of transmission data, and transmitting uplink data including the selected rate request code to the BS.

According to the present invention, there is provided a method for receiving data in a wireless access communication system, including a rate request code predefined according to a traffic rate individually for each MS, extracting the rate request code from the received data, selecting a traffic rate corresponding to the extracted rate request code, and allocating uplink wireless resources at the selected traffic rate, and transmitting the allocated uplink wireless resources to a corresponding MS.

According to the present invention, there is provided an apparatus for transmitting data in a wireless access communication system, including an uplink MAP parser for acquiring uplink resource allocation amount information from an uplink MAP received from a BS, a rate request code selector for selecting a corresponding rate request code from among rate request codes predefined according to a traffic rate considering the uplink resource allocation amount information and a size of transmission data, and a transmitter for transmitting uplink data including the selected rate request code to the BS.

According to the present invention, there is provided a method for transmitting data in a wireless access communication system, including receiving an uplink MAP from a BS, and acquiring uplink resource allocation amount information from the uplink MAP, selecting a corresponding rate request code from among rate request codes predefined according to a traffic rate considering the uplink resource allocation amount information and a size of transmission data, and transmitting uplink data including the selected rate request code to the BS.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates a schematic configuration of a conventional communication system;

FIG. 2 illustrates a conventional VoIP data transport frame;

FIG. 3 illustrates VA codes and their associated traffic rates according to the present invention;

FIG. 4 illustrates changing definitions of VA codes according to the present invention;

FIG. 5 illustrates a structure of a BS according to the present invention;

FIG. 6 illustrates a structure of an MS for transmitting voice data according to the present invention;

FIG. 7 illustrates an operation of a VA code selector in an MS according to the first embodiment of the present invention;

FIG. 8 illustrates an operation of a VA code processor in a BS according to the first embodiment of the present invention;

FIG. 9 illustrates an operation of a VA code selector in an MS according to a second embodiment of the present invention;

FIG. 10 illustrates an operation of a VA code processor in a BS according to the second embodiment of the present invention; and

FIG. 11 illustrates a VoIP data frame according to the present invention.

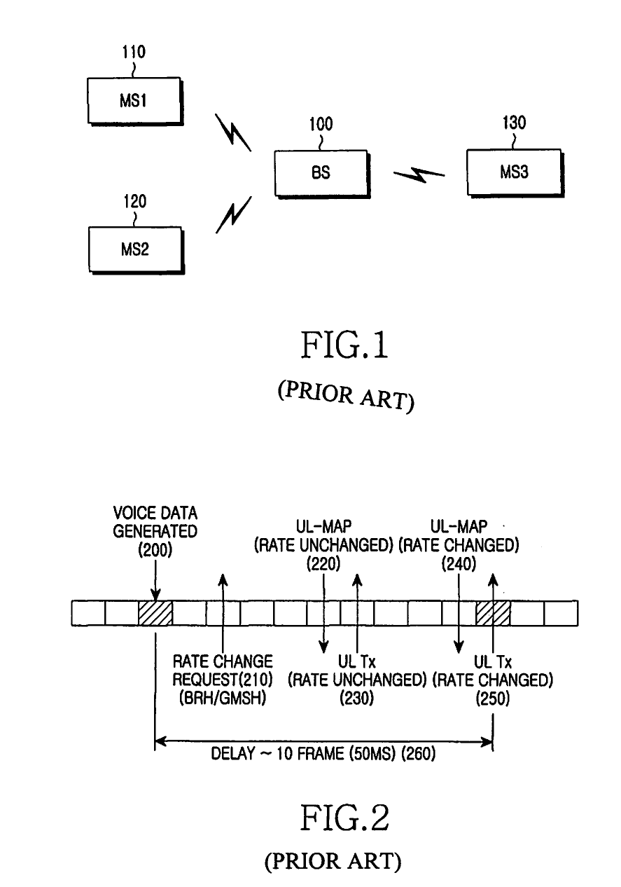

### DETAILED DESCRIPTION OF THE PREFERRED EMBODIMENTS

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for the sake of clarity and conciseness.

The present invention provides a method for rapidly transmitting data using a code predetermined between an MS and a BS, instead of a MAC message having a long message generation and processing time. Although the data transmission method can be applied not only to the voice data but also to the real-time data, it will be applied herein to the voice data, by way of example.

The present invention defines a Voice Activity Code (hereinafter VA code) to which a traffic rate for data transmission/reception between an MS and a BS is mapped. The traffic rate can be predefined by default between the MS and the BS, or can be defined through negotiation between the MS and the BS during transport connection setup.

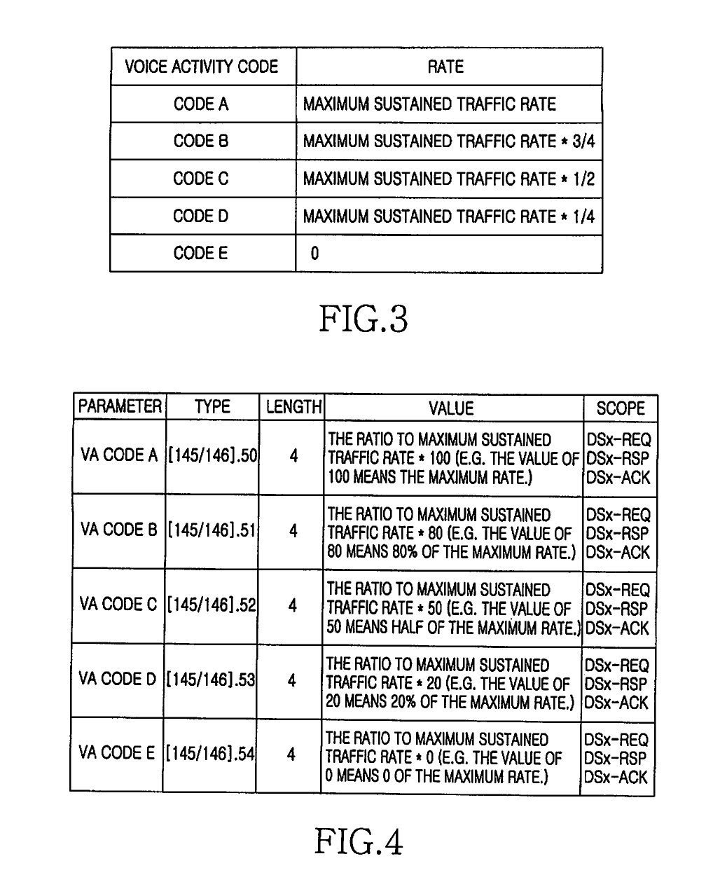

FIG. 3 illustrates VA codes and their associated traffic rates according to the present invention.

Referring to FIG. 3, VA codes include five codes of code A, code B, code C, code D and code E, and traffic rates associated with the VA codes are each defined as a relative ratio to ‘Maximum Sustained Traffic Rate’.

Code A indicates Maximum Sustained Traffic Rate, code B indicates ½ (0.5) of Maximum Sustained Traffic Rate, code C indicates ¼ (0.25) of Maximum Sustained Traffic Rate, and code D indicates ⅛ (0.125) of Maximum Sustained Traffic Rate.

When there is an intention to change a traffic rate for a VA code defined individually for each MS as shown in FIG. 3, the MS and BS can change a definition of the corresponding VA code by exchanging messages, in each of which a TLV field composed of Type, Length and Value fields is defined. Specifically, a desired traffic rate is defined in a Value field of the corresponding VA code. The messages include Subscriber Station's Basic Capability Negotiation REQuest/ReSPonse (SBC-REQ/RSP) messages, Registration REQuest/ReSPonse (REG-REQ/RSP) messages, Dynamic Service Addition REQuest/ReSPonse (DSA-REQ/RSP) messages, and the like.

FIG. 4 illustrates an example of changing definitions of VA codes through DSA-REQ/RSP messages according the present invention.

Referring to FIG. 4, as to a TLV field for changing definitions of VA codes, parameters, i.e. Lengths of VA codes, are all ‘4’, and Scopes indicating messages including the TLV field are all equal. The Scope includes therein a DSx-REQ message, a DSx-RSP message and a DSx-ACK message. In each of the messages, a relative ratio to Maximum Sustained Traffic Rate changed through message exchange between an MS and a BS is included in the Value field individually for each VA code. There are various possible examples in addition to the relative ratios shown in FIG. 3.

Although the embodiment can allow a user to select a rate request code by measuring the amount of generated voice data input to an MS, an alternative embodiment can allow the MS to receive not only the voice data but also real-time generated data such as video information due to activity of the user and various measurement data, to measure the amount of corresponding data generated per length of time or the amount of the input data in a buffer, and to previously set the rate request code. A description will now be made of an operation and structure in which a BS receives a VA code from an MS and allocates uplink resources based on a traffic rate corresponding to the received VA code according to a first embodiment of the present invention.

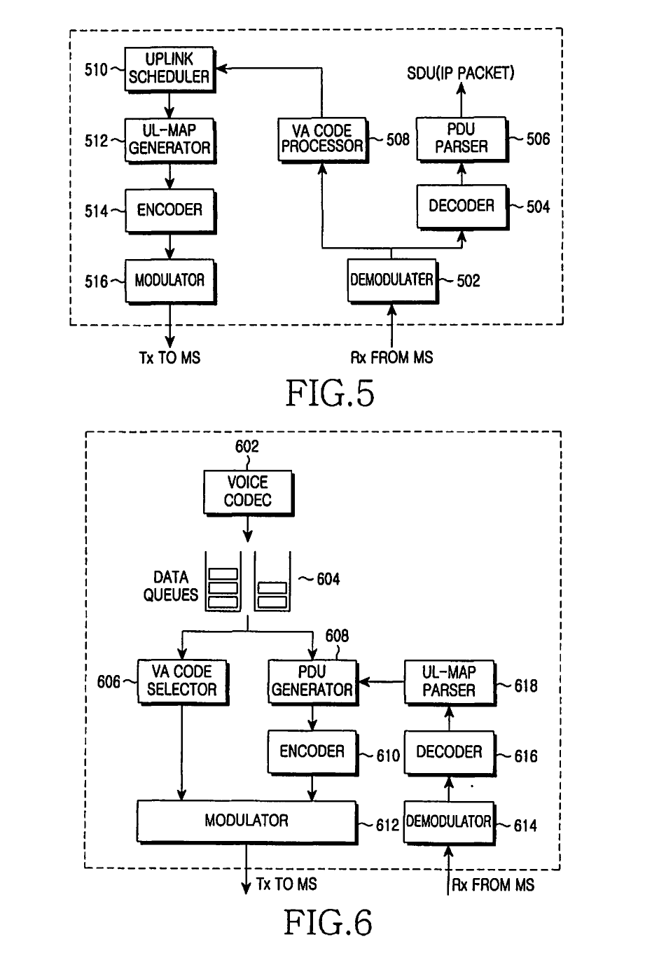

FIG. 5 illustrates a structure of a BS according to the present invention.

Referring to FIG. 5, the BS includes a demodulator 502, a decoder 504, a Packet Data Unit (PDU) parser 506, a VA code processor 508, an uplink scheduler 510, an UpLink MAP (UL-MAP) generator 512, an encoder 514 and a modulator 516. The BS receives uplink burst and PDU from a corresponding MS. The demodulator 502 demodulates the received uplink burst and PDU, and outputs the result to the decoder 504 and the VA code processor 508. The decoder 504 performs decoding on the demodulated uplink burst and PDU, and outputs the result to the PDU parser 506.

The PDU parser 506 extracts a Service Data Unit (SDU) from the decoded uplink burst and PDU. The VA code processor 508 acquires a VA code from the demodulated uplink burst and PDU. Thereafter, the VA code processor 508 changes, to an uplink resource allocation amount, a traffic rate associated with a corresponding VA code which is predefined with the MS or defined through negotiation during transport connection setup as shown in FIG. 3, and then transfers the uplink resource allocation amount to the uplink scheduler 510.

The uplink scheduler 510 allocates uplink wireless resources based on the uplink resource allocation amount received from the VA code processor 508. The UL-MAP generator 512 generates a UL-MAP according to the allocated uplink wireless resources, and inputs the UL-MAP to the encoder 514. The encoder 514 performs encoding on the UL-MAP, and then transfers the result to the modulator 516, which modulates the encoded UL-MAP, and transmits the result to the corresponding MS.

FIG. 6 illustrates a structure of an MS for transmitting voice data according to the present invention.

Referring to FIG. 6, the MS includes a voice codec 602, data queues 604, a VA code selector 606, a PDU generator 608, an encoder 610, a modulator 612, a demodulator 614, a decoder 616 and a UL-MAP parser 618.

The demodulator 614 demodulates a UL-MAP received from the BS, and outputs the result to the decoder 616. The decoder 616 decodes the demodulated UL-MAP, and transfers the result to the UL-MAP parser 618. The UL-MAP parser 618 acquires uplink resource allocation amount information from the decoded UL-MAP, and outputs the result to the PDU generator 608. The PDU generator 608 generates a PDU based on the uplink wireless resources, and outputs the PDU to the encoder 610, which encodes the PDU, and outputs result to the modulator 612.

The voice codec 602 generates data through source coding and inputs the result to the data queues 604, which store the data. The data can include voice data and real-time data.

When the data is stored in the data queues 604, the VA code selector 606 reads a size of the data stored in the data queues 604, selects a VA code considering the size of the voice data stored in the data queues 604 and its Maximum Sustained Traffic Rate negotiated during connection setup with the BS, and transfers the selected VA code to the modulator 612.

Thereafter, the modulator 612 modulates the encoded PDU and VA code to generate uplink burst and PDU, and transmits them to the BS over the corresponding transport connection.

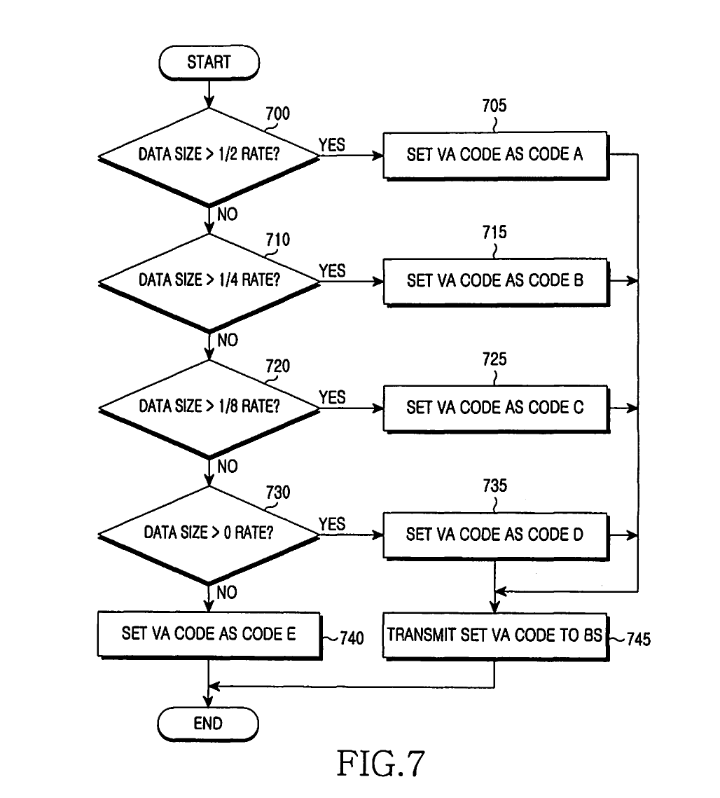

With reference to FIG. 7, a detailed description will now be made of an operation in which the VA code selector 606 selects a VA code.

The selected VA code is transmitted to a BS after undergoing modulation by means of the modulator 612. Before transmitting the selected VA code to the BS, an MS checks whether a request for uplink resource allocation from the MS to the BS is a request for periodic allocation or temporary allocation, and then determines how it will transmit the VA code to the BS according to the check result.

In the first embodiment of the present invention, when the MS periodically sends a request for uplink resource allocation to the BS, the MS sends the request to the BS every time the VA code is selected. When no voice data is generated, a VA code indicating that a rate is ‘0’ is not transmitted to the BS, and if there is no VA code transmitted from the MS, the BS recognizes that a rate of the corresponding MS is ‘0’.

FIG. 7 illustrates an operation of a VA code selector in an MS according to the first embodiment of the present invention. It is assumed herein that the VA code is previously negotiated during transport connection setup between a BS and an MS as shown in FIG. 3.

Referring to FIG. 7, the MS determines in step 700 whether a size of corresponding data is greater than ½ of Maximum Sustained Traffic Rate for Unsolicited Grant Interval. If it is determined that the data size is greater than ½ of Maximum Sustained Traffic Rate, the MS sets a VA code as ‘code A’ in step 705, and then proceeds to step 745.

However, if it is determined that the data size is equal to or less than ½ of Maximum Sustained Traffic Rate, the MS determines in step 710 whether the data size is greater than ¼ of Maximum Sustained Traffic Rate for Unsolicited Grant Interval. If it is determined that the data size is greater than ¼ of Maximum Sustained Traffic Rate, the MS sets a VA code as ‘code B’ in step 715, and then proceeds to step 745.

However, if it is determined that the data size is equal to or less than ¼ of Maximum Sustained Traffic Rate, the MS determines in step 720 whether the data size is greater than ⅛ of Maximum Sustained Traffic Rate for Unsolicited Grant Interval. If it is determined that the data size is greater than ⅛ of Maximum Sustained Traffic Rate, the MS sets a VA code as ‘code C’ in step 725, and then proceeds to step 745.

However, if it is determined that the data size is equal to or less than ⅛ of Maximum Sustained Traffic Rate, the MS determines in step 730 whether the data size is greater than zero (0) for Unsolicited Grant Interval. If it is determined that the data size is greater than 0, the MS sets a VA code as ‘code D’ in step 735, and then proceeds to step 745. If it is determined that the size of the voice activity information is 0, the MS sets a VA code as ‘code E’ in step 740, and then ends the operation.

In step 745, the MS transmits the set VA code to the BS.

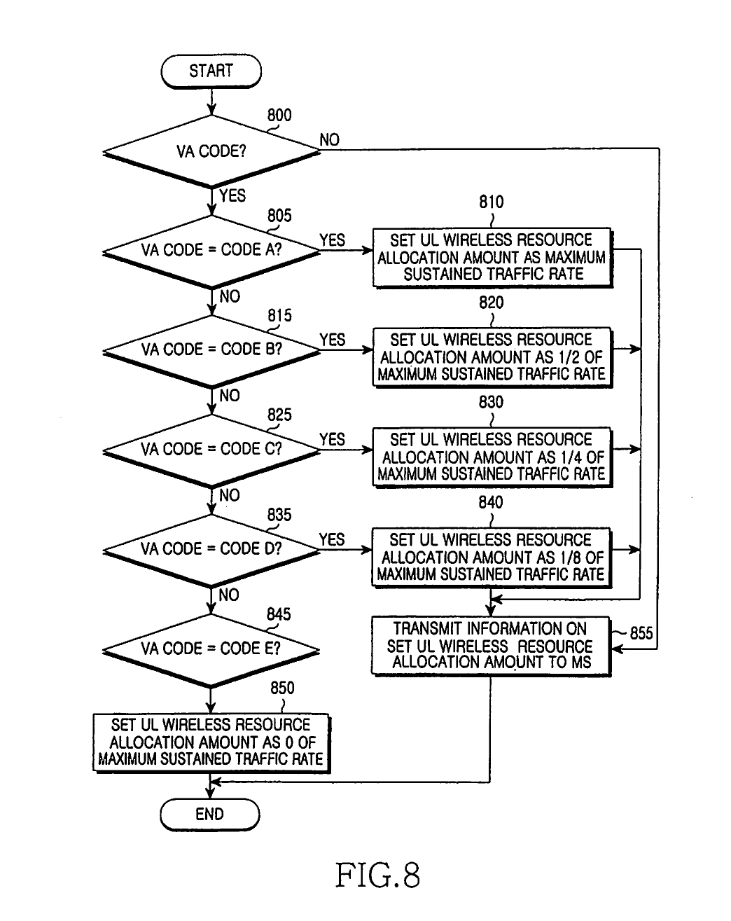

FIG. 8 illustrates an operation of a VA code processor in a BS according to the first embodiment of the present invention.

Referring to FIG. 8, the BS receives uplink burst and PDU data over a dedicated channel set individually for each MS. Upon receipt of the data, the BS demodulates the received data by means of a demodulator 502 and a VA code processor 508 determines in step 800 whether determines whether there is a VA code in it. If it is determined that there is no VA code, the VA code processor 508 proceeds to step 855.

However, if it is determined that there is a VA code, the VA code processor 508 determines in step 805 whether the VA code is ‘code A’. If it is determined that the VA code is ‘code A’, the VA code processor 508 changes (or sets) an uplink wireless resource allocation amount as Maximum Sustained Traffic Rate in step 810, and then proceeds to step 855. However, if it is determined that the VA code is not ‘code A’, the VA code processor 508 determines in step 815 whether the VA code is ‘code B’. If it is determined that the VA code is ‘code B’, the VA code processor 508 changes an uplink wireless resource allocation amount as ½ of Maximum Sustained Traffic Rate in step 820, and then proceeds to step 855.

However, if it is determined that the VA code is not ‘code B’, the VA code processor 508 determines in step 825 whether the VA code is ‘code C’. If it is determined that the VA code is ‘code C’, the VA code processor 508 changes an uplink wireless resource allocation amount as ¼ of Maximum Sustained Traffic Rate in step 830, and then proceeds to step 855.

However, if it is determined that the VA code is not ‘code C’, the VA code processor 508 determines in step 835 whether the VA code is ‘code D’. If it is determined that the VA code is ‘code D’, the VA code processor 508 changes an uplink wireless resource allocation amount as ⅛ of Maximum Sustained Traffic Rate in step 840, and then proceeds to step 855.

However, if it is determined that the VA code is not ‘code D’, the VA code processor 508 determines in step 845 whether the VA code is ‘code E’. If it is determined that the VA code is ‘code E’, the VA code processor 508 changes an uplink wireless resource allocation amount as 0 in step 850 and then ends the operation

In step 855, the BS transmits information on the uplink wireless resource allocation amount to the corresponding MS.

Thereafter, upon receipt of the information, the MS recognizes that the uplink rate, change of which was requested by the MS itself over the VA code, is changed.

In a second embodiment of the present invention, when a request for uplink wireless allocation from an MS to a BS is a request for temporary allocation, the MS compares the VA code with the last transmitted VA code and transmits the VA code only when it was changed. Even for the VA code indicating that a traffic rate is ‘0’, the MS compares the VA code with the last transmitted VA code, and transmits the VA code to the BS when it was changed.

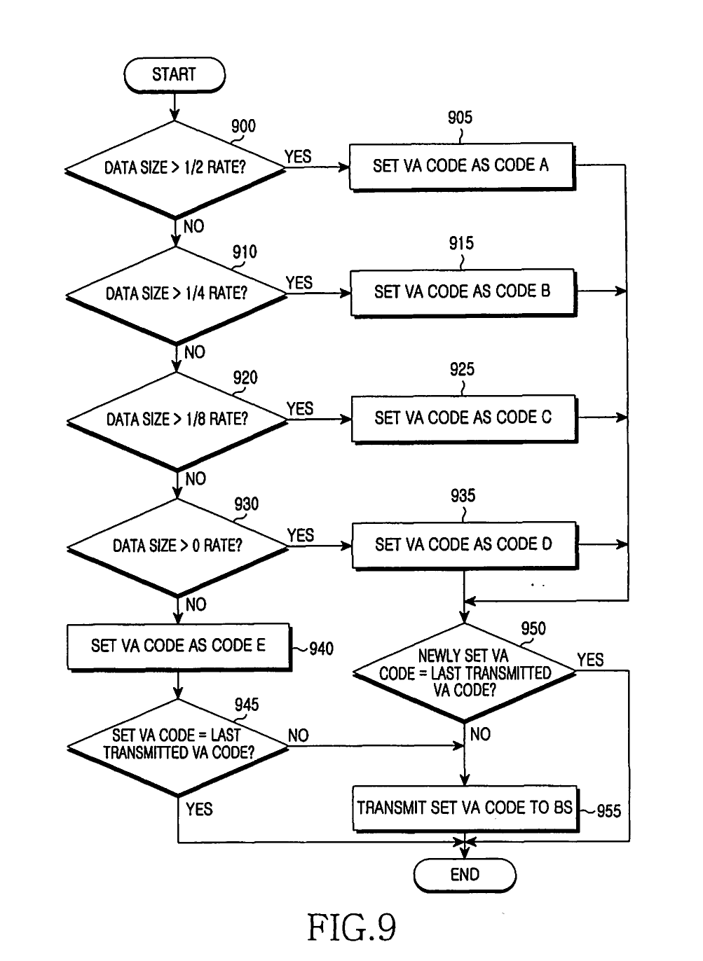

FIG. 9 illustrates an operation of a VA code selector in an MS according to a second embodiment of the present invention. It is assumed herein that the VA code is defined during transport connection setup between a BS and an MS as shown in FIG. 3.

Referring to FIG. 9, the MS determines in step 900 whether a size of corresponding data is greater than ½ of Maximum Sustained Traffic Rate for Unsolicited Grant Interval. If it is determined that the data size is greater than ½ of Maximum Sustained Traffic Rate, the MS sets a VA code as ‘code A’ in step 905, and then proceeds to step 950.

However, if it is determined that the data size is equal to or less than ½ of Maximum Sustained Traffic Rate, the MS determines in step 910 whether the data size is greater than ¼ of Maximum Sustained Traffic Rate for Unsolicited Grant Interval. If it is determined that the data size is greater than ¼ of Maximum Sustained Traffic Rate, the MS sets a VA code as ‘code B’ in step 915, and then proceeds to step 950.

However, if it is determined that the data size is equal to or less than ¼ of Maximum Sustained Traffic Rate, the MS determines in step 920 whether the data size is greater than ⅛ of Maximum Sustained Traffic Rate for Unsolicited Grant Interval. If it is determined that the data size is greater than ⅛ of Maximum Sustained Traffic Rate, the MS sets a VA code as ‘code C’ in step 925, and then proceeds to step 950.

However, if it is determined that the data size is equal to or less than ⅛ of Maximum Sustained Traffic Rate, the MS determines in step 930 whether the data size is greater than 0 of Maximum Sustained Traffic Rate for Unsolicited Grant Interval. If it is determined that the data size is greater than 0 of Maximum Sustained Traffic Rate, the MS sets a VA code as ‘code D’ in step 935, and then proceeds to step 950.

If it is determined that the data size is 0, the MS sets a VA code as ‘code E’ in step 940, and then proceeds to step 945.

In step 945, the MS determines whether the set code E is equal to the last transmitted VA code. If it is determined that the set code E is not equal to the last transmitted VA code, the MS proceeds to step 955. However, if it is determined that the set code E is equal to the last transmitted VA code, the MS ends the operation.

In step 950, the MS determines whether the set VA code is equal to the last transmitted VA code. If the set VA code is equal to the last transmitted VA code, the MS ends the operation. However, if the set VA code is not equal to the last transmitted VA code, the MS transmits the set VA code to the BS in step 955, and then end the operation.

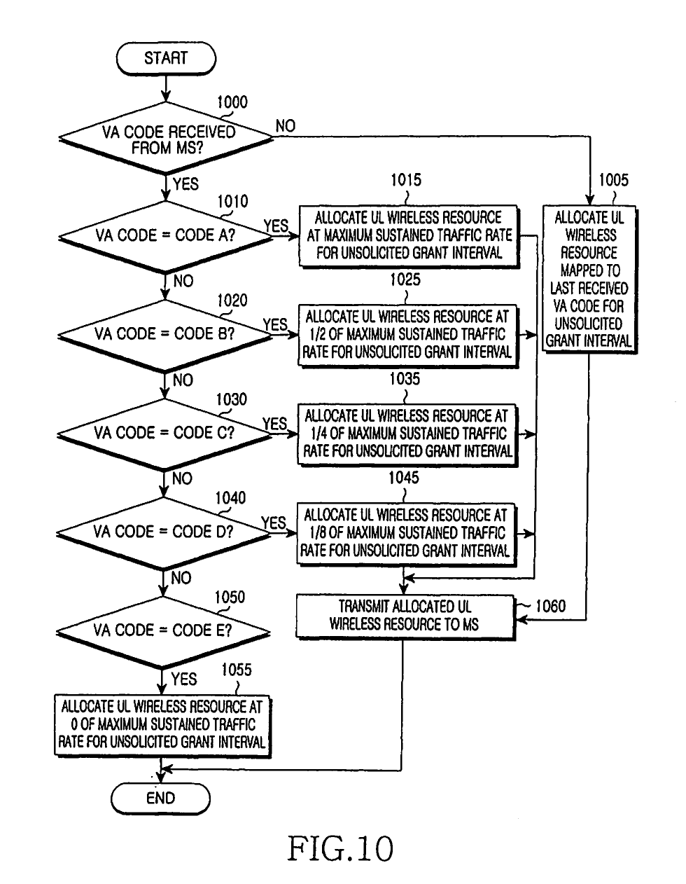

FIG. 10 illustrates an operation of a VA code processor in a BS according to the second embodiment of the present invention.

Referring to FIG. 10, the BS determines in step 1000 whether uplink burst and PDU data are received from a corresponding MS. Upon receipt of the uplink burst and PDU data, the BS demodulates the received data by means of a demodulator 502 and determines whether there is a VA code in it. If it is determined that there is no VA code, the VA code processor 508 proceeds to step 1005 where it allocates uplink wireless resources for the last received VA code for Unsolicited Grant Interval.

However, if it is determined that there is a VA code, the VA code processor 508 determines in step 1010 whether the VA code is ‘code A’. If it is determined that the VA code is ‘code A’, the VA code processor 508 allocates uplink wireless resources at Maximum Sustained Traffic Rate for Unsolicited Grant Interval in step 1015, and then proceeds to step 1060.

However, if it is determined that the VA code is not ‘code A’, the VA code processor 508 determines in step 1020 whether the VA code is ‘code B’. If it is determined that the VA code is ‘code B’, the VA code processor 508 allocates uplink wireless resources at ½ of Maximum Sustained Traffic Rate for Unsolicited Grant Interval in step 1025, and then proceeds to step 1060.

However, if it is determined that the VA code is not ‘code B’, the VA code processor 508 determines in step 1030 whether the VA code is ‘code C’. If it is determined that the VA code is ‘code C’, the VA code processor 508 allocates uplink wireless resources at ¼ of Maximum Sustained Traffic Rate for Unsolicited Grant Interval in step 1035, and then proceeds to step 1060.

However, if it is determined that the VA code is not ‘code C’, the VA code processor 508 determines in step 1040 whether the VA code is ‘code D’. If it is determined that the VA code is ‘code D’, the VA code processor 508 allocates uplink wireless resources at ⅛ of Maximum Sustained Traffic Rate for Unsolicited Grant Interval in step 1045, and then proceeds to step 1060.

However, if it is determined that the VA code is not ‘code D’, the VA code processor 508 determines in step 1050 whether the VA code is ‘code E’. If it is determined that VA code is ‘code E’, the VA code processor 508 allocates uplink wireless resources at 0 of Maximum Sustained Traffic Rate for Unsolicited Grant Interval in step 1055, and then ends the operation.

In step 1060, the BS transmits the allocated uplink wireless resources to the corresponding MS for Unsolicited Grant Interval.

Thereafter, the MS recognizes that the uplink rate is changed through its requested VA code. To transmit the selected VA code to the BS according to the first embodiment or the second embodiment, the MS follows the following third to fifth embodiments.

In the third embodiment of the present invention, the MS transmits the VA code to the BS over a dedicated channel for transmitting uplink wireless resources allocated individually for each MS, for example, over the uplink dedicated channel allocated depending on a Channel Quality Indication (CQI) channel of Institute of Electrical and Electronics Engineers (IEEE) 802.16. The CQI channel is a channel used by the MS to report a Carrier-to-Interference and Noise Ratio (CINR) or to send other necessary signaling.

In the fourth embodiment of the present invention, the MS sends the set VA code together with a user identifier indicating each corresponding MS, over an uplink channel shared by multiple MSs. For example, the MS scrambles or spreads the VA code with the user identifier before transmission.

Finally, in the fifth embodiment of the present invention, the MS transmits a VA code set allocated separately for each individual user. That is, different VA code sets are allocated for individual users.

For example, a user #1 uses a first VA code set having 5 VA codes of code A, code B, code C, code D and code E, and a user #2 uses a second VA code set having 5 VA codes of code F, code G. code H, code I and code J. The first VA code set and the second VA code set can be equal in terms of traffic rates for the codes therein, or can be different because the traffic rates for the VA codes are negotiated individually for each connection. In this case, while the user #1 transmits the code A to allocate uplink wireless resources at Maximum Sustained Traffic Rate, the user #2 transmits the code F to allocate uplink wireless resources at Maximum Sustained Traffic Rate.

As described above, the first and second embodiments in which before transmitting the selected VA code to the BS, the MS selects the VA code of the data to be transmitted to the BS, are both applied to each of the third, fourth and fifth embodiments, in which the MS transmits the VA code to the BS. Combination of the embodiments would be obvious to those skilled in the art, so a detailed description thereof will be omitted herein.

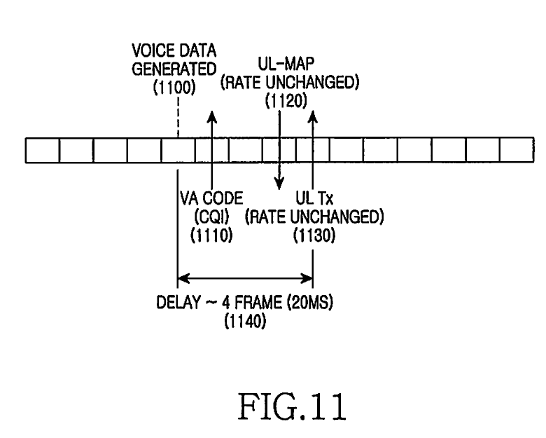

FIG. 11 illustrates a VoIP data frame according to the present invention.

Referring to FIG. 11, a length of each frame is 5 ms, and the corresponding frame is assumed to be applied to the third embodiment.

When the VoIP service using the silence suppression technology is provided through the ertPS service, if VoIP data is generated from a voice codec of an MS (see 1100), the MS sends a request for rate change to a BS over a dedicated channel (or CQI channel) considering a size of the generated VoIP data queue (see 1110).

Upon receipt of the rate change request from the MS, the BS performs a change procedure to the rate requested by the MS, and provides information on the allocated uplink wireless resources to the MS over the dedicated channel for Unsolicited Grant Interval (see 1120). Thereafter, the MS transmits the VoIP data according to the uplink wireless resources allocated from the BS (see 1130).

That is, the UL voice data transmission to which the rate change is applied is possible after a lapse of about 20 ms (see 1140) from the generation time 1100 of the voice data. This shows noticeable improvement, compared to the delay time of about 50 ms (see 260 of FIG. 2) in the existing ertPS service.

As is apparent from the foregoing description, according to the present invention, the MS sends a request for uplink wireless resource allocation to the BS using a VA code indicating a traffic rate predefined between the MS and the BS, and the BS allocates uplink wireless resources at the traffic rate corresponding to the VA code, thereby contributing to an increase in the efficiency of wireless resources and a decrease in the voice data transmission delay time.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for transmitting data in a wireless access communication system, the apparatus comprising:
a rate request code selector for selecting a corresponding rate request code from among rate request codes predefined according to a traffic rate; and
a transmitter for transmitting the selected rate request code to a Base Station (BS).

2. The apparatus of claim 1, wherein the data includes voice data and real-time data.

3. The apparatus of claim 1, wherein the rate request code is indicated as a relative ratio to Maximum Sustained Traffic Rate indicating a traffic rate maximally allocable for a corresponding connection.

4. The apparatus of claim 3, wherein the rate request code is a relative ratio to Maximum Sustained Traffic Rate, defined through negotiation with the BS.

5. The apparatus of claim 1, wherein when periodically sending a request for uplink wireless resource allocation to the BS, the rate request code selector sends an uplink wireless resource allocation request including the elected rate request code to the BS every time the rate request code is selected.

6. The apparatus of claim 5, wherein when there is no data generated, the rate request code selector does not transmit a rate request code mapped to a rate of zero (0) to the BS.

7. The apparatus of claim 1, wherein when temporarily sending a request for uplink wireless resource allocation to the BS, the rate request code selector compares the rate request code with a last received rate request code, and transmits the rate request code when it is changed.

8. The apparatus of claim 1, wherein the transmitter transmits the selected rate request code to the BS over a dedicated channel.

9. The apparatus of claim 1, wherein the transmitter transmits an identifier of a corresponding Mobile Station (MS) to the BS over a shared channel together with the selected rate request code.

10. The apparatus of claim 1, wherein the transmitter transmits a rate request code set individually allocated for each user.

11. An apparatus for receiving data in a wireless access communication system, the apparatus comprising:
a receiver for receiving data including a rate request code predefined according to a traffic rate individually for each of a plurality of Mobile Stations (MSs);
a demodulator for extracting the rate request code from the received data;
a rate request code processor for selecting a traffic rate corresponding to the extracted rate request code and allocating uplink wireless resources at the selected traffic rate; and
a transmitter for transmitting the allocated uplink wireless resources to a corresponding MS.

12. The apparatus of claim 11, wherein the data includes voice data and real-time data.

13. The apparatus of claim 11, wherein the rate request code is indicated as a relative ratio to Maximum Sustained Traffic Rate indicating a traffic rate maximally allocable for a corresponding connection.

14. The apparatus of claim 11, wherein the rate request code is a relative ratio to Maximum Sustained Traffic Rate, defined through negotiation with a corresponding MS.

15. The apparatus of claim 11, wherein the receiver allocates uplink wireless resources to the MS according to a rate request code included in an uplink wireless resource allocation request periodically received from the MS.

16. The apparatus of claim 11, wherein the receiver does not receive a rate request code mapped to a rate of zero (0) if there is no data generated in the MS.

17. The apparatus of claim 11, wherein when temporarily receiving a request for uplink wireless resource allocation from the MS, the receiver receives the rate request code when it is changed from a last received rate request code.

18. The apparatus of claim 11, wherein the receiver receives the rate request code over a dedicated channel.

19. The apparatus of claim 11, wherein the receiver receives an identifier of a corresponding MS over a shared channel together with the rate request code.

20. The apparatus of claim 11, wherein the receiver receives a rate request code set individually allocated for each user.

21. A method for transmitting data in a wireless access communication system, the method comprising:
receiving an uplink Media Access Protocol (MAP) from a Base Station (BS), and acquiring uplink resource allocation amount information from the uplink MAP;
selecting a corresponding rate request code from among rate request codes predefined according to a traffic rate considering the uplink resource allocation amount information and a size of transmission data; and
transmitting uplink data including the selected rate request code to the BS.

22. The method of claim 21, wherein the data includes voice data and real-time data.

23. The method of claim 21, wherein the rate request code is indicated as a relative ratio to Maximum Sustained Traffic Rate indicating a traffic rate maximally allocable for a corresponding connection.

24. The method of claim 21, wherein the rate request code is a relative ratio to Maximum Sustained Traffic Rate, defined through negotiation with the BS.

25. The method of claim 21, wherein the transmitting further comprises:
when periodically sending a request for uplink wireless resource allocation to the BS, sending an uplink wireless resource allocation request including the selected rate request code to the BS every time the rate request code is selected.

26. The method of claim 25, wherein the selecting further comprises:
when there is no data generated, transmitting no rate request code mapped to a rate of zero (0) to the BS.

27. The method of claim 21, wherein the selecting further comprises:
when temporarily sending a request for uplink wireless resource allocation to the BS, comparing the rate request code with a last received rate request code, and transmitting the rate request code when it is changed.

28. The method of claim 21, wherein the transmitting further comprises:
transmitting the selected rate request code to the BS over a dedicated channel.

29. The method of claim 21, wherein the transmitting further comprises:
transmitting an identifier of a corresponding Mobile Station (MS) to the BS over a shared channel together with the selected rate request code.

30. The method of claim 21, wherein the transmitting further comprises:
transmitting a rate request code set individually allocated for each user.

31. A method for receiving data in a wireless access communication system, the method comprising:
receiving data including a rate request code predefined according to a traffic rate individually for each of a plurality of Mobile Stations (MSs);
extracting the rate request code from the received data, selecting a traffic rate corresponding to the extracted rate request code, and allocating uplink wireless resources at the selected traffic rate; and
transmitting the allocated uplink wireless resources to a corresponding MS.

32. The method of claim 31, wherein the data includes voice data and real-time data.

33. The method of claim 31, wherein the rate request code is indicated as a relative ratio to Maximum Sustained Traffic Rate indicating a traffic rate maximally allocable for a corresponding connection.

34. The method of claim 31, wherein the rate request code is a relative ratio to Maximum Sustained Traffic Rate, defined through negotiation with a corresponding MS.

35. The method of claim 31, wherein the receiving further comprises:
allocating uplink wireless resources to the MS according to a rate request code included in an uplink wireless resource allocation request periodically received from the MS.

36. The method of claim 31, wherein the receiving further comprises:
receiving no rate request code mapped to a rate of zero (0) if there is no data generated in the MS.

37. The method of claim 31, wherein the receiving further comprises:
when temporarily receiving a request for uplink wireless resource allocation from the MS, receiving the rate request code when it is changed from a last received rate request code.

38. The method of claim 31, wherein the receiving further comprises:
receiving the rate request code over a dedicated channel.

39. The method of claim 31, wherein the receiving further comprises:
receiving an identifier of a corresponding MS over a shared channel together with the rate request code.

40. The method of claim 31, wherein the receiving further comprises:
receiving a rate request code set individually allocated for each user.

41. An apparatus for transmitting data in a wireless access communication system, the apparatus comprising:
an uplink Media Access Protocol (MAP) parser for acquiring uplink resource allocation amount information from an uplink MAP received from a Base Station (BS);
a rate request code selector for selecting a corresponding rate request code from among rate request codes predefined according to a traffic rate considering the uplink resource allocation amount information and a size of transmission data; and
a transmitter for transmitting uplink data including the selected rate request code to the BS.

42. The apparatus of claim 41, wherein the data includes voice data and real-time data.

43. The apparatus of claim 41, wherein the rate request code is indicated as a relative ratio to Maximum Sustained Traffic Rate indicating a traffic rate maximally allocable for a corresponding connection.

44. The apparatus of claim 43, wherein the rate request code is a relative ratio to Maximum Sustained Traffic Rate, defined through negotiation with the BS.

45. The apparatus of claim 41, wherein when periodically sending a request for uplink wireless resource allocation to the BS, the rate request code selector sends an uplink wireless resource allocation request including the selected rate request code to the BS every time the rate request code is selected.

46. The apparatus of claim 45, wherein when there is no data generated, the rate request code selector does not transmit a rate request code mapped to a rate of zero (0) to the BS.

47. The apparatus of claim 41, wherein when temporarily sending a request for uplink wireless resource allocation to the BS, the rate request code selector transmits the rate request code when it is changed from a last received rate request code.

48. The apparatus of claim 41, wherein the transmitter transmits the selected rate request code to the BS over a dedicated channel.

49. The apparatus of claim 41, wherein the transmitter transmits an identifier of a corresponding Mobile Station (MS) to the BS over a shared channel together with the selected rate request code.

50. The apparatus of claim 41, wherein the transmitter transmits a rate request code set individually allocated for each user.

51. A method for transmitting data in a wireless access communication system, the method comprising:
receiving an uplink Media Access Protocol (MAP) from a Base Station (BS), and acquiring uplink resource allocation amount information from the uplink MAP;
selecting a corresponding rate request code from among rate request codes predefined according to a traffic rate considering the uplink resource allocation amount information and a size of transmission data; and
transmitting uplink data including the selected rate request code to the BS.

52. The method of claim 51, wherein the data includes voice data and real-time data.

53. The method of claim 51, wherein the rate request code is indicated as a relative ratio to Maximum Sustained Traffic Rate indicating a traffic rate maximally allocable for a corresponding connection.

54. The method of claim 51, wherein the rate request code is a relative ratio to Maximum Sustained Traffic Rate, defined through negotiation with the BS.

55. The method of claim 51, wherein the transmitting further comprises:
when periodically sending a request for uplink wireless resource allocation to the BS, sending an uplink wireless resource allocation request including the selected rate request code to the BS every time the rate request code is selected.

56. The method of claim 55, wherein the selecting further comprises:
when there is no data generated, transmitting no rate request code mapped to a rate of zero (0) to the BS.

57. The method of claim 51, wherein the selecting further comprises:
when temporarily sending a request for uplink wireless resource allocation to the BS, transmitting the rate request code when it is changed from a last received rate request code.

58. The method of claim 51, wherein the transmitting further comprises:
transmitting the selected rate request code to the BS over a dedicated channel.

59. The method of claim 51, wherein the transmitting further comprises:
transmitting an identifier of a corresponding Mobile Station (MS) to the BS over a shared channel together with the selected rate request code.

60. The method of claim 51, wherein the transmitting further comprises:
transmitting a rate request code set individually allocated for each user.
